(19) United States
(12) Patent Application Publication
(10) Pub. No.: US 2007/0200916 A1
(43) Pub. Date: Aug. 30, 2007

(54) Apparatus and method of controlling access to user information through face recognition in video phone

(76) Inventor: Yong-Hee Han, Suwon-si (KR)

Correspondence Address: Robert E. Bushnell;Suite 300, 1522 K Street, N.W., Washington, DC, 20005-1202, US

(21) Appl. No.: 11/645,635

(22) Filed: Dec. 27, 2006

(30) Foreign Application Priority Data
Feb. 10, 2006 (KR) 10-2006-0013301

(51) Int. Cl. H04N 7/14

(52) U.S. Cl. 348/14.01

(57) ABSTRACT

In an apparatus and method for controlling access to user information in a videophone with a camera, when access to user information for performing an arbitrary function of the videophone is requested, the videophone photographs the face image of the user using the camera, compares the photographed face image of the user with at least one image of previously stored user face images, and controls the access to the user information required for performing the arbitrary function on the basis of the result of the comparison.

### CLAIM OF PRIORITY

his application makes reference to, incorporates the same herein, and claims all benefits accruing under 35 U.S.C.§119 from an application for APPARATUS AND METHOD OF CONTROLLING ACCESS OF USER INFORMATION THROUGH FACE RECOGNITION IN VIDEO PHONE earlier filed in the Korean Intellectual Property Office on the 10^{th} of Feb. 2006 and there duly assigned Serial No. 10-2006-0013301.

### BACKGROUND OF THE INVENTION

1. Technical Field

The present invention relates to an apparatus and method for controlling access to user information in a videophone and, more particularly, to an apparatus and method for controlling access to user information in a videophone through face recognition so that only an authorized user can access his/her own user information when access limitation to the user information is requested.

2. Related Art

With the continuous development of communication and electronic technologies, a videophone with a video call function has been developed.

Such a videophone provides various additional functions required for a voice call and a video call.

For example, one of the additional functions is a user information database for separately storing a telephone directory, a message service mailbox, schedule information, and so on, for each user to retrieve and change information stored in the user information database.

That is, the videophone includes a user information database for each user, and each user can retrieve and change his/her information stored in the user information database.

However, the information stored in the user information database may be retrieved or changed by an undesired user.

In order to solve this problem, the videophone performs an authorization process for determining whether a user is authorized to access the user information database when access to the user information database is requested.

At this point, the authorization of the user for access to the user information database is performed by inputting a password for access to the user information database, and confirming the validity of the inputted password.

As a result of the authorization, when the user is determined to be an authorized user, the videophone allows the user to access the user information database.

The videophone performs the authorization of the user whenever access to the user information database is requested.

Therefore, the user who wants to access the user information database should pass the authorization whenever the user accesses the user information database.

### SUMMARY OF THE INVENTION

It is an object of the present invention to provide an apparatus and method for controlling access to user information in a videophone through face recognition so that only an authorized user can access his/her own user information when limited access the user information is required.

A first aspect of the present invention provides an apparatus for controlling access to user information in a videophone with a camera, comprising: a database for storing at least one user information set by at least one user; and a controller for photographing a user's face using the camera when user's information is required for performing an arbitrary function of the videophone, and allowing the user to access the user information required for performing the arbitrary function when the photographed face image of the user is identical to at least one face image of previously stored images.

The controller may display the user information and user identification information required for performing the arbitrary function on a screen when the photographed face image of the user is identical to at least one face image of the previously stored images.

The controller may limit access to the user information required for performing the arbitrary function when the photographed face image of the user is not identical to at least one face image of the previously stored images.

The controller may display a message that the user cannot access the user information required for performing the arbitrary function on the screen when the photographed face image of the user is not identical to at least one face image of the previously stored images.

A second aspect of the present invention provides a method of controlling access to user information in a videophone having a camera and a database for storing at least one user information set by at least one user, the method comprising the steps of: photographing a user's face using the camera when user information is required for performing an arbitrary function of the videophone; and allowing the user to access the user information required for performing the arbitrary function when the photographed face image of the user is identical to at least one face image of the previously stored images.

The step of allowing the user to access the user information required for performing the arbitrary function may comprise the step of displaying the user information and user identification information required for performing the arbitrary function on a screen when the photographed face image of the user is identical to at least one face image of the previously stored images.

The step of controlling access to user information in a videophone may further comprise the step of limiting access to the user information required for performing the arbitrary function when the photographed face image of the user is not identical to at least one face image of the previously stored images.

The step of limiting access to the user information required for performing the arbitrary function may comprise the step of displaying a message that the user cannot access the user information required for performing the arbitrary function, when the photographed face image of the user is not identical to at least one face image of the previously stored images.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of an apparatus for controlling access to user information in a videophone in accordance with an exemplary embodiment of the present invention;

FIG. 2 is a flowchart illustrating a method of controlling access to user information in a videophone in accordance with an exemplary embodiment of the present invention; and

FIG. 3 illustrates an example of a user information interface, including information required for an arbitrary function and user identification information, in accordance with the present invention.

### DETAILED DESCRIPTION OF THE INVENTION

Reference will now be made in detail to the embodiments of the present invention, examples of which are illustrated in the accompanying drawings, wherein like reference numerals refer to like elements throughout.

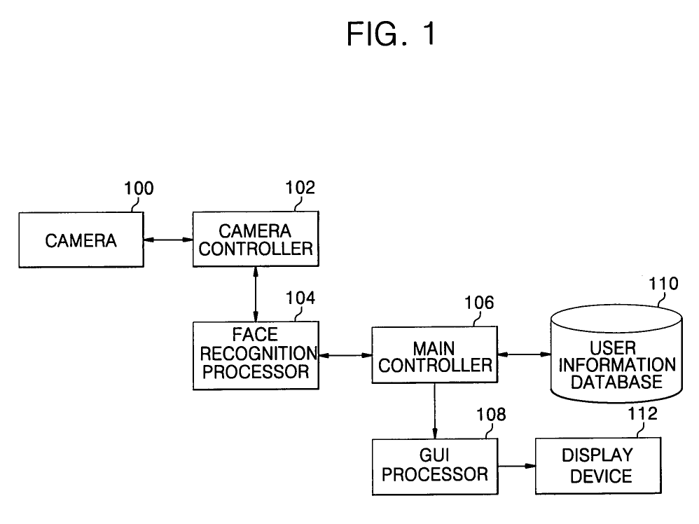

FIG. 1 is a block diagram of an apparatus for controlling access to user information in a videophone in accordance with an exemplary embodiment of the present invention.

As shown in FIG. 1, an apparatus for controlling access to user information in a videophone in accordance with the present invention includes a camera 100, a camera controller 102, a face recognition processor 104, a main controller 106, a graphic user interface (GUI) processor 108, a user information database 110, and a display device 112.

The main controller 106 generates a face recognition control signal so as to provide it to the face recognition processor 104 when it is required for a user to access the user information database storing user information, such as a telephone directory, a short message service (SMS) mailbox, schedule information, and so on, which is set by the user to perform an arbitrary function of a videophone.

For example, the operation of the arbitrary function in the videophone indicates the case wherein the user requires access to the telephone directory for a video call of the videophone.

When the face recognition control signal is received from the main controller 106, the face recognition processor 104 generates a camera driving signal so as to provide it to the camera controller 102.

When the camera driving signal is received from the face recognition processor 104, the camera controller 102 provides an image of the user photographed by the camera 100 to the face recognition processor 104.

The face recognition processor 104 compares the user's image provided by the camera controller 102 with at least one image of the previously stored face images, and generates a face image validity signal or invalidity signal as a result of the comparison so as to provide the validity or invalidity signal to the main controller 106.

Hereinafter, a face recognition process of the face recognition processor 104 will be described in detail.

The face recognition processor 104 extracts only an image of a face region contained in the entire image of the user provided by the camera controller 102, and extracts features from the extracted face image of the user.

In this process, the extraction of the user's face image contained in the user's image may be performed by a method using brightness information, a method using motion information, a method using brightness and motion information, or a method using color information.

In addition, the extraction of features of the extracted face image of the user may be performed by a method of extracting an eigen-vector using a Karhunen-Loeve Transform (KLT), a method of extracting direction information of the image and magnitude of a slope using a Hough Transform, a method of extracting features of the image using distances between eyes, a nose and a mouth, a method using Principal Component Analysis, or a method using Linear Discriminant Analysis.

The face recognition processor 104 compares the extracted features of the user's face image with features of at least one image of the previously stored face images, and generates a face image validity signal or invalidity signal as a result of the comparison so as to provide the validity or invalidity signal to the main controller 106.

At this point, the comparison of the extracted features of the user's face image and the features of at least one image of the previously stored face images may be performed by a neural network, a nearest neighbor classifier, or a support vector machine.

When the face validity signal is provided by the face recognition processor 104, the main controller 106 selects information required to perform an arbitrary function from the user information database 110 so as to provide the information to the GUI processor 108.

The GUI processor 108 configures a user information interface, including the information required for an arbitrary function selected by the main controller 106 and user identification information, and displays the interface on a screen of the display device 112.

At this point, the user identification information may be a user's name.

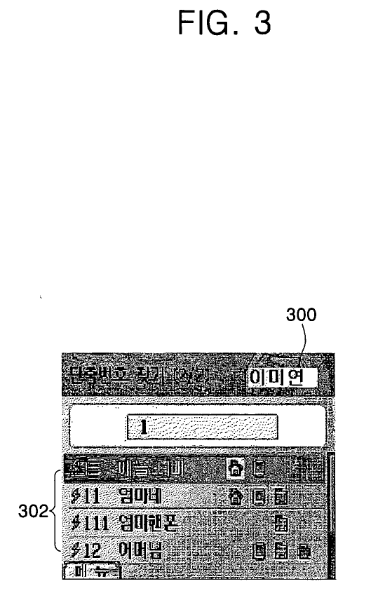

FIG. 3 illustrates an example of a user information interface, including information required for an arbitrary function and user identification information, in accordance with the present invention.

As shown in FIG. 3, the user information interface includes user identification information 300, and information 302 required for performing an arbitrary function.

The information 302 required for performing the arbitrary function may include at least one telephone number, and the arbitrary function may be a video call or a voice call on a videophone.

When the face image invalidity signal is provided by the face recognition processor 104, the main controller 106 controls the GUI processor 108 to display information indicating that the user cannot access the user information database 110.

Therefore, the GUI processor 108 generates a message indicating that the user cannot access the user information database 110, and displays the message on the display device 112.

Meanwhile, the user information database 10 stores at least one user information, such as a telephone directory, an SMS mailbox, schedule information, and so on, personalized with respect to at least one user.

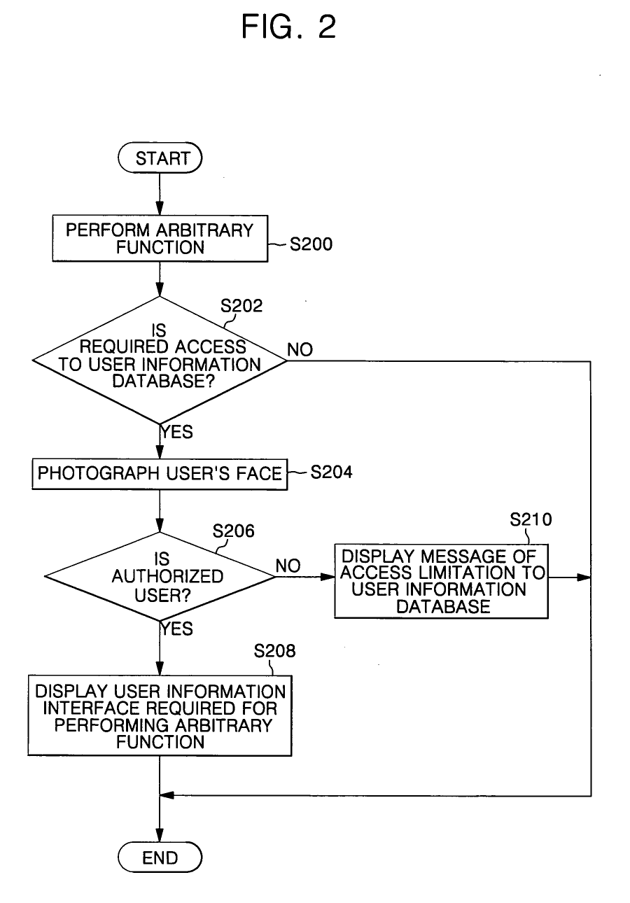

FIG. 2 is a flowchart illustrating a method of controlling access to user information in a videophone in accordance with an exemplary embodiment of the present invention.

As shown in FIG. 2, a videophone in accordance with the present invention determines whether it is required for a user to access the user information database storing user information, such as a telephone directory, an SMS mailbox, schedule information, and so on, personalized with respect to the user, during operation of an arbitrary function of the videophone (S200).

In this process, the operation of the arbitrary function in the videophone relates to the case wherein the user requires access to the telephone directory for a video call or the videophone.

When it is required to access the user information database in which user information for performing an arbitrary function is stored (S202), the videophone photographs the user's face using a camera (S204).

Then, the videophone determines whether the photographed face image is identical to at least one face image of the previously stored images (S206).

That is, the videophone determines whether the photographed user is a registered user who may access the user information database.

The above determination will now be described in detail.

The videophone removes a background image included in the user's face image photographed by the camera so as to extract the user's face image only, and extracts features of the extracted face image of the user.

The videophone compares the features of the extracted face image of the user with the features of at least one of the previously stored face images, and determines on the basis of the comparison whether the photographed user can access the user information database.

When the photographed user's face image is identical to the face image of at least one of the previously stored images, the videophone constitutes a user information interface required for performing the arbitrary function, and displays it on a screen (S208).

At this point, the user information interface required for performing the arbitrary function includes user identification information (for example, a user's name), and information required for performing the arbitrary function.

The arbitrary function may be a video call or a voice call or the videophone, and the user information required for performing the arbitrary function may be at least one telephone number of a receiver of the video call or the voice call.

Meanwhile, when the user's face image photographed in step S204 is not identical to any one of the previously stored images, the videophone generates a message indicating that the user cannot access the user information database, and displays the message on the screen (S210).

As can be seen from the foregoing, the apparatus and method for controlling access to user information in a videophone in accordance with the present invention enables a user to access the user information only when the user is an authorized user having authorization to access the user information through face recognition, as opposed to the inputting of a password for accessing a user information database and determining whether the inputted password is valid.

While the present invention has been described with reference to exemplary embodiments thereof, it will be understood by those skilled in the art that various changes in form and detail may be made therein without departing from the scope of the present invention as defined by the following claims.

What is claimed is:

1. An apparatus for controlling access to user information in a videophone with a camera, comprising:
a database for storing user information set by a user; and
controller means for photographing a face of a user using the camera when user information is required for performing an arbitrary function of the videophone, and for allowing the user to access the user information required for performing the arbitrary function when the photographed face image of the user is identical to at least one face image of previously stored images.

2. The apparatus according to claim 1, wherein the controller means displays the user information required for performing the arbitrary function and user identification information on a screen when the photographed face image of the user is identical to said at least one face image of the previously stored images.

3. The apparatus according to claim 1, wherein the controller means limits access to the user information required for performing the arbitrary function when the photographed face image of the user is not identical to said at least one face image of the previously stored images.

4. The apparatus according to claim 3, wherein the controller means displays on the screen a message indicating that the user cannot access the user information required for performing the arbitrary function when the photographed face image of the user is not identical to said at least one face image of the previously stored images.

5. The apparatus according to claim 1, wherein the controller means comprises a camera controller connected to the camera for controlling the camera.

6. The apparatus according to claim 5, wherein the controller means further comprises a face recognition processor connected to the camera controller for processing the photographed face image of the user.

7. The apparatus according to claim 6, wherein the controller means further comprises a main controller connected to the face recognition processor and to the database for allowing the user to access the user information required for performing the arbitrary function of the videophone when the photographed face image of the user is identical to said at least one face image of the previously stored images.

8. The apparatus according to claim 7, wherein the controller means further comprises a graphic user interface (GUI) processor connected to the main controller and a display device connected to the GUI processor, the GUI processor displaying a message on the display device indicating whether the user is allowed to access the user information required for performing the arbitrary function.

9. The apparatus according to claim 1, wherein the controller means comprises a face recognition processor for processing the photographed face image of the user.

10. The apparatus according to claim 9, wherein the controller means further comprises a main controller connected to the face recognition processor and to the database for allowing the user to access the user information required for performing the arbitrary function of the videophone when the photographed face image of the user is identical to said at least one face image of the previously stored images.

11. The apparatus according to claim 1, wherein the controller means comprises a main controller connected to the database for allowing the user to access the user information required for performing the arbitrary function of the videophone when the photographed face image of the user is identical to said at least one face image of the previously stored images.

12. A method of controlling access to user information in a videophone having a camera and a database for storing user information set by a user, the method comprising the steps of:
photographing a face of a user using the camera when the user information is required for performing an arbitrary function of the videophone; and
allowing the user to access the user information required for performing the arbitrary function when the photographed face image of the user is identical to at least one face image of previously stored images.

13. The method according to claim 12, wherein the step of allowing the user to access the user information required for performing the arbitrary function comprises the step of displaying the user information required for performing the arbitrary function and user identification information on a screen when the photographed face image of the user is identical to said at least one face image of the previously stored images.

14. The method according to claim 12, further comprising the step of limiting access to the user information required for performing the arbitrary function when the photographed face image of the user is not identical to said at least one face image of the previously stored images.

15. The method according to claim 14, wherein the step of limiting access to the user information required for performing the arbitrary function comprises the step of displaying on the screen a message indicating that the user cannot access the user information required for performing the arbitrary function when the photographed face image of the user is not identical to said at least one face image of the previously stored images.
